(19) United States
(12) Patent Application Publication
(10) Pub. No.: US 2011/0238600 A1
(43) Pub. Date: Sep. 29, 2011

(54) ORGANIC WASTE DECOMPOSITION EXCHANGE SYSTEM

(76) Inventor: Sean Siehoon Lee, Irvine, CA (US)

(21) Appl. No.: 13/071,304

(22) Filed: Mar. 24, 2011

Related U.S. Application Data
(60) Provisional application No. 61/318,210, filed on Mar. 26, 2010.
(60) Provisional application No. 61/438,597, filed on Feb. 1, 2011.

(51) Int. Cl. G06Q 90/00; B65G 49/00

(52) U.S. Cl. 705/500; 414/800

(57) ABSTRACT

A method of managing organic waste decomposition includes providing an organic waste decomposition machine adapted to transform organic waste into decomposed material at a first site, collecting the decomposed material output by the organic waste decomposition machine, and transporting the decomposed material to a second site. The collecting and transporting the decomposed material are performed in exchange for providing the organic waste decomposition machine.

### RELATED APPLICATIONS

This application claims priority under 35 U.S.C. §119(e) to and is a nonprovisional of U.S. Application No. 61/318,210 filed Mar. 26, 2010, entitled “Organic Waste Decomposition Exchange System,” and U.S. Application No. 61/438,597, filed Feb. 1, 2011, entitled “System and Method of Organic Waste Processing for Organic Biomass Recovery and Generation of Feedstock for Use in Hydro Thermochemical Conversion,” the disclosures of which are hereby incorporated by reference in their entirety.

### BACKGROUND

Recent federal statistics indicate that nearly 65 million tons of food waste and organic waste are generated annually in the United States, but only 3% are recycled, composted, or given as animal feed. The remainder is disposed in landfills or incinerators. Composting of organic waste is considered an environmentally friendly treatment by naturally decomposing the biodegradable organic waste via anaerobic digestion processes. Once decomposed, the converted materials can be used as mulch or soil amendments. However, the decomposition process takes a long time and is increasingly regulated because the decaying process generates foul odors and methane gas. Methane gas is known to have as much as 20˜25 times more potent impact to greenhouse gases. In addition, it requires substantial carbon footprints to transfer the waste to a composting site, waste transfer station, or remote landfills. Thus, there is a need for more effective processes and systems to treat organic food waste.

### SUMMARY

In certain embodiments, a service provider provides an onsite organic (e.g., food) waste decomposition or conversion system. The customer sites where the service can be offered can include, among others, commercial food service providers, food manufacturing sites, cattle or pig slaughter houses, waste transfer stations, landfills and waste water treatment facilities where biodegradable organic waste or biosolids (e.g., sewage sludges) are collected. Such special machines or systems may be provided to customer sites in exchange (at least in part) for a service fee, the benefit of not having to pay or reducing a waste hauling fee, to enable carbon credit or to meet laws or regulations related to carbon emissions, and/or the rights to collect the output generated by the machine. The service provider can provide the machine to the customer, who uses the machine to reduce the organic waste at the site everyday through a waste reduction and biomass conversion process. The process also involves a sterilization process and thus creates sanitary working environment by eliminating negative impacts caused by the organic food waste, such as foul odor, liquid contents, vermin (rats and roaches) and disease-transmitting agents (such as E. coli and samonella) residing in the contaminated food waste. The machine produces decomposed material and clean water extracted from the waste as byproducts. The decomposed material, sometimes referred to as “converted material”, can include highly concentrated organic (HCO) particles, biomass particles, carbonaceous material, or the like. It should be noted that in certain embodiments, the machine decomposes or otherwise converts organic waste without using bacteria, enzymes, or other microorganisms. The service provider can collect the “decomposed material”. Further, the service provider can market the decomposed material to third parties or can transform the decomposed material into another byproduct.

In certain embodiments, the organic waste decomposition machine includes a decomposition chamber that converts organic material at the customer site. A deodorizer can reduce foul odors produced during decomposition. In one embodiment, the conversion process is controlled by heat sensors inside the chamber, a pre-programmed heat cycle, steam, air flow and controlled pressure.

A blower and air controller can create an flow of steam and control relative humidity during the conversion process inside the decomposition chamber.

In one embodiment, a method of managing onsite organic waste decomposition includes providing an organic waste decomposition machine adapted to reduce and transform organic waste into clean, decomposed material at a first site, collecting the decomposed material output by the organic waste decomposition machine; and transporting the decomposed material to a second site; wherein said collecting and transporting the decomposed material are performed in exchange for said providing the organic waste decomposition machine.

The organic waste decomposition machine is configured to: decompose organic waste in a decomposition chamber such that the decomposition chamber heats the organic waste to release moisture therefrom and continue to heat the moisture and organic waste to decompose, whereby steam is generated in the decomposition chamber, and whereby the decomposed material is produced, condense the steam passing through a condenser in fluid communication with the decomposition chamber via a conduit to precipitate water, flow steam from the decomposition chamber to the condenser with a blower in fluid communication with the decomposition chamber and the condenser, and supply precipitated water to the decomposition chamber by a water circuit in fluid communication between the condenser and the decomposition chamber. Advantageously, in one embodiment, the decomposition process does not require the presence and/or addition of any microorganisms, enzymes, or fresh water.

The method can further include transforming the decomposed material into one or more of the following: a soil amendment or soil enhancer, biofuel, animal or livestock feed materials, or an organic filler for ABS resin or plastics.

In another embodiment, a method of managing organic waste decomposition includes: providing an organic waste decomposition machine adapted to transform organic waste into decomposed material at a first site, the organic waste decomposition machine configured to apply heat to the organic waste in a decomposition chamber to produce decomposed material; collecting the decomposed material output by the organic waste decomposition machine; and transporting the decomposed material to a second site (or it can be conducted at the same site if the amount of decomposed material is big enough, such as a waste transfer station, landfills or some hotels, which can produce more than 10 tons of food waste daily); wherein said collecting service fees (e.g., in exchange for the reduction of the waste) and byproducts and transporting the decomposed material are performed in exchange for said providing the organic waste decomposition machine.

The organic waste decomposition machine can be further configured to at least partially recycle water generated from the organic waste, apply the recycled water into the decomposition chamber and cleans the filters and pipes to avoid the clogging of the system. Indeed, recycled water may be used to clear and clean internal filters, which helps prevent blockages from occurring and the system from clogging. The method can further include transforming the decomposed material into one or more of the following: a soil amendment, biomass fuel or an organic filler for acrylonitrile butadiene styrene (ABS) resin,

The organic waste decomposition machine can be configured to transform the organic waste into the decomposed material. The method can further include providing a credit to an operator of the first site, an amount of the credit depending at least partly on an amount of the decomposed material collected. The collecting the decomposed material can be performed according to an arrangement between an operator of the first site and a provider of the organic waste decomposition machine.

In another embodiment, a method of managing organic waste decomposition includes: providing an organic waste decomposition machine to a customer, the organic waste decomposition machine adapted to decompose organic waste at a site of the customer; and arranging to receive decomposed material output by the organic waste decomposition machine for transportation to a second site; wherein said arranging to receive the decomposed material output by the organic waste decomposition machine is performed in exchange for said providing the organic waste decomposition machine.

The method can also include transforming the decomposed material into one or more of the following: an organic filler that can be used as filler for acrylonitrile butadiene styrene (ABS), a soil amendment, and biofuel. The organic waste decomposition machine can be configured to transform the organic waste into the decomposed material. The method can also include providing a credit to an operator of the first site, an amount of the credit depending at least partly on an amount of the decomposed material collected. Furthermore, the collecting the decomposed material can be performed according to an arrangement between an operator of the first site and a provider of the organic waste decomposition machine.

In another embodiment, an organic waste decomposition apparatus includes: a decomposition chamber configured to decompose organic waste therein such that the decomposition chamber heats the organic waste to release moisture therefrom and continue to heat the moisture and organic waste to decompose, whereby steam is generated in the decomposition chamber; a condenser in fluid communication with the decomposition chamber via a conduit and configured to precipitate water from the steam passing therethrough; a blower in fluid communication with the decomposition chamber and the condenser, the blower being configured to flow steam from the decomposition chamber to the condenser; and a water circuit in fluid communication between the condenser and the decomposition chamber, the water circuit configured to supply precipitated water to the decomposition chamber; wherein the organic waste decomposition apparatus is provided to a facility to thereby decompose the organic waste produced at the facility, and wherein the decomposed organic waste is collected from the facility in exchange for providing the organic waste decomposition machine to the facility.

The system may also include: one or more filters between the decomposition chamber and the condenser, the one or more filter being configured to screen debris from the decomposition chamber; and a flusher configured to flush debris deposited on the one or more filters. The flusher may be provided in fluid communication with the water circuit and configured to use the at least part of the precipitated water for flushing. The water circuit can include a water tank configured to at least temporarily store precipitated water therein. The water circuit can include a water pump configured to flow precipitated water from the water tank toward the decomposition chamber. The water circuit can include a water filter configured to filter at least part of the precipitated water that is discharged from the system. The water filter can include an activated carbon filter (or any other filtration system to filter heavy metal or harmful components in the steam such as chromium or to neutralize (e.g., the pH level) the condensate water). The water circuit may be configured to supply precipitated water to the decomposition chamber when the organic waste is in shortage of moisture for decomposing (or cleaning filters and systems, as described above).

For purposes of summarizing the disclosure, certain aspects, advantages and novel features of the inventions have been described herein. It is to be understood that not necessarily all such advantages may be achieved in accordance with any particular embodiment of the inventions disclosed herein. Thus, the inventions disclosed herein may be embodied or carried out in a manner that achieves or optimizes one advantage or group of advantages as taught herein without necessarily achieving other advantages as may be taught or suggested herein.

### BRIEF DESCRIPTION OF THE DRAWINGS

Throughout the drawings, reference numbers may be re-used to indicate correspondence between referenced elements. The drawings are provided to illustrate embodiments of the inventions described herein and not to limit the scope thereof.

FIG. 1 illustrates an embodiment of a process for providing an organic waste decomposing machine in exchange for a service fee or for collecting decomposed waste produced by the organic waste decomposing machine;

FIG. 2 illustrates another embodiment of a process for providing an organic waste decomposition machine in exchange for collecting decomposed waste or for a service fee;

FIG. 3 illustrates an embodiment of a process for decomposing waste with an organic waste decomposition machine;

FIG. 4 is a block diagram of an organic waste decomposing system according to one embodiment;

FIG. 5 is a more detailed illustration of the organic waste decomposing system of FIG. 4;

FIG. 6 is a block diagram of a control system of an organic waste decomposing system according to one embodiment;

FIG. 7 illustrates flow of moisture during an organic waste decomposing process according to one embodiment; and

FIGS. 8A through 8C illustrate embodiments of decomposition business models.

### DETAILED DESCRIPTION

Traditionally, waste disposal companies collect organic waste from customer sites and transfer the waste to a local transfer station. From the local transfer station, the waste is moved to a variety of possible disposal sites, including landfills, compost sites, and incinerators. In addition, some waste is transported to anaerobic digestion plants for processing and reuse.

There are several downsides to this waste disposal process. The hauling, operation, and transfer of waste result in high costs and pollutant emissions from waste disposal vehicles. Organic waste, in particular food waste, also tends to generate a significant amount of methane gas, which can have twenty-five times the greenhouse effect of carbon dioxide on the environment. Organic waste also generates many side effects during storage and transformation, such as foul odor, attracting of vermin, and the like. Moreover, much organic waste is merely disposed of and not recycled.

Instead of hauling organic waste away from a customer's facility to a separate processing site, in certain embodiments a service provider can place an organic waste decomposition machine at the customer's facility. The organic waste decomposition machine can advantageously decompose the customer's organic waste in a shorter amount of time than can be obtained by composting. The service provider can sell and/or market the machine or in exchange for providing the machine, the service provider can collect a service fee and/or decomposed material produced by the machine. The service provider can further transform the decomposed material into other products or sell the decomposed material to third parties.

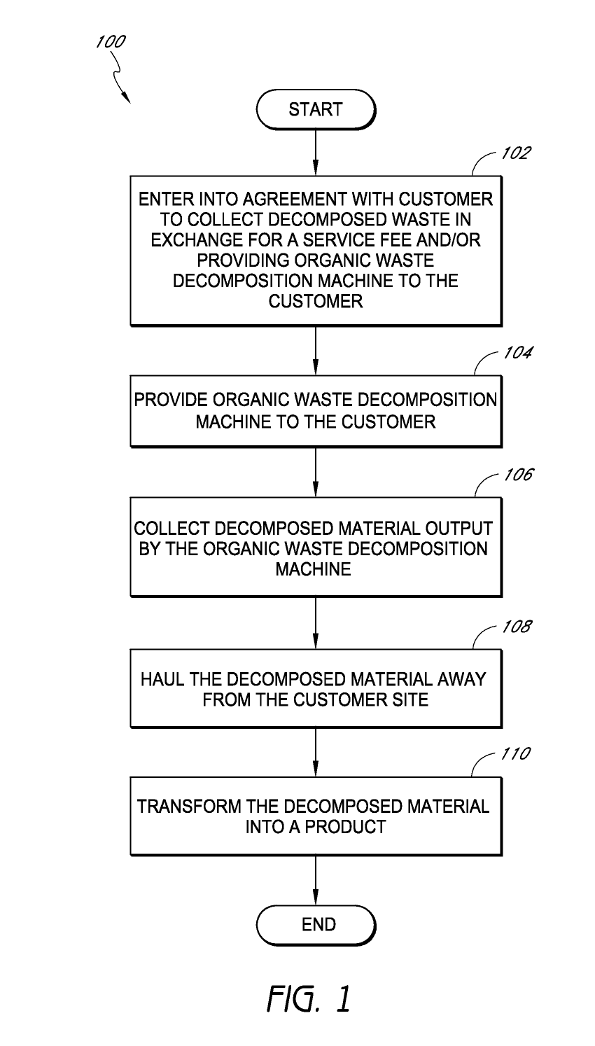

In yet another embodiment, the organic waste decomponsition machine is provided in connection with a franchise operation. For example, in certain embodiments, a service provider works with agents or franchisees that co-own or co-invest into purchasing a machine. In another embodiment, such individuals form a franchise contract with the service provider. The agents (e.g., franchisees) receive a portion of the service fees, carbon credit and/or profits by providing services (e.g., machine installation, converted material pickup, and byproduct conversion) for the service provider. The service provider can implement these features according to a waste removal process 100 described below with respect to FIG. 1. Advantageously, in certain embodiments, the waste removal process 100 provides a mechanism for recycling organic waste in a cost-effective manner.

Referring to block 102 of FIG. 1, a service provider can enter into an agreement with a customer to collect decomposed waste in exchange for a service fee or for providing an organic waste decomposition machine to the customer. The service provider can sell, lease, rent, or otherwise transfer at least a portion (or all) of property rights in the machine to the customer. The agreement can be a contract that provides terms for providing the machine, collecting decomposed waste, and payment, among other features. The contract can be formed for the joint purpose to benefit both the customer and the service provider.

At block 104, the service provider can provide an organic waste decomposition machine to the customer. By providing the machine, the service provider can deliver the machine to the customer, or alternatively, the customer can pick up the machine from the service provider. The service provider can deliver the machine to the customer's site, facility, or the like, or to any site indicated by the customer.

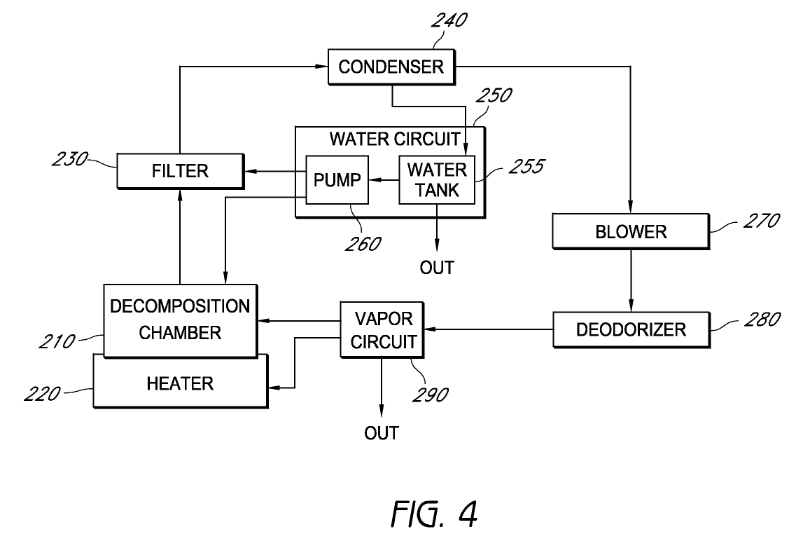

Generally, the organic waste decomposition machine can automatically decompose organic material provided to the machine by the customer. Advantageously, in certain embodiments, the organic waste decomposition machine can decompose the organic material to produce decomposed material in a time period of about 4-24 hours or less. In certain embodiments, the organic waste decomposition machine can perform this processing at a high temperature without burning the organic material and without releasing significant amounts of water. An example organic waste decomposition machine is described below with respect to FIGS. 4 through 7.

Although this specification is primarily described in the context of a machine having the features described below with respect to FIGS. 4 through 7, the processes described herein are in no way limited to a machine having these features. Instead, any organic waste decomposition machine can be provided by the service provider at least in part in exchange for the right to collect the output of the machine.

In one embodiment, the customer purchases the machine from the service provider. In another embodiment, the customer leases the machine from the service provider. In yet another embodiment, the service provider provides the machine to the customer without charge. The service provider can receive other forms of consideration in place of payment for the machine, examples of which are described below.

The service provider collects the decomposed material output by the organic waste decomposition machine at block 106. The service provider can haul the decomposed material away from the customer site (or other site where the machine is located) at block 108. The service provider can collect the decomposed material at periodic intervals, such as once per day, once per week, once per month, twice per week, twice per month, or at another interval. In another embodiment, the service provider collects the decomposed material upon customer request, for example, when the customer has generated a certain amount of decomposed material.

For example, in some embodiments, the decomposition machine includes a sensor, such as a weight sensor, a heat sensor, a timer, etc., which determines the amount of waste that has been decomposed. The decomposition machine further includes a communication link, such as a wireless communication (e.g., wireless telephone, cell phone, etc.), a network connection, transmitter, a transceiver, and/or a radio, etc., to notify the service provider, or his agent, when the decomposed material is ready to be removed and collected from the machine and to remotely monitor the service and maintenance of the system.

In addition, in some embodiments the machine further includes electronic circuitry, including for example one or more sensors, a microprocessor, and a communication interface, that allows remote access and configuration of the decomposition machine. For example, in some embodiments, a service provider is able to remotely reset the machine (e.g., reset control software, reset a counter, a weight scale, etc.) or perform other service functions, including reading machine output values and other indicia of machine status, performance, state, health, error, age, duration, cycles, etc. Such remote access can be achieved over the Internet, over a private or other public network (or combination) via a wired and/or wireless connection.

In some embodiments the service provider is able to optimize the pickup route and timing of decomposed material from one or more decomposition machines based upon information remotely (or non-remotely) received from the decomposition machines. For example, the service provider may utilize a computer or other processor-based device to employ an optimization routine designed to minimize the carbon footprint (e.g., number of pickup runs, trucks on the road, etc.) required to pick up the most amount of decomposed matter from the greatest number of decomposition machines. In some embodiments, one or more alarms are communicated from the machine to a service provider over any one of the networks or other mechanisms described herein. Such alarms include alarms that the machine is full, the machine requires service, power outage, malfunction, safety alarm, user error, etc.

In certain embodiments, a subcontractor of the service provider collects and hauls away the decomposed material instead of or in addition to the service provider. The subcontractor can operate as an agent or under the direction of the service provider. The customer can pay (or share the profit with) the subcontractor for collection and hauling fees in addition to or instead of the service provider. The subcontractor can remit at least a portion of any fees collected to the service provider.

Instead of or in addition to charging for the machine, the service provider can charge for or receive carbon credit for the waste reduction at the customer site and/or the periodic collection and removal of decomposed material output by the machine. The service provider can charge a flat fee each month or other period, a fee that depends on the amount of decomposed material collected, or some other fee. Advantageously, in some embodiments, the service provider can charge a pick-up fee that is based on the amount of decomposed material collected. The rates the service provider charges can be comparable to or the same as the current waste hauling expenses of the customer. As the hauled waste can be smaller in size, the service provider can charge less than the customer is used to paying for waste hauling.

In one embodiment, the service provider neither charges for the machine nor the collection and hauling of the decomposed material. Instead, the service provider collects the decomposed material as consideration for providing the machine for the customer's use. In another embodiment, the service provider pays the customer for the decomposed material. In another embodiment, the service provider credits an account of the customer for the decomposed material. In another embodiment, the service provider reduces a bill for the customer based at least partly on the amount of decomposed material collected. Any combination of the above-described payment or credit structures could be employed in various embodiments.

At block 108, the decomposed material is transformed into a product. This block can be implemented by the service provider directly. Alternatively, the service provider can sell the decomposed material to a third party who transforms the material into a product. Examples of products that can incorporate the decomposed material include filler for acrylonitrile butadiene styrene (ABS) resin and biofuels (e.g., biomass pellet, syngas, or Substitute Natural Gas). For example, in some embodiments, the decomposed material is combined with steam and a binding agent to form a biofuel pellet. Suitable binding agents include, but are not limited to, sawdust, shredded paper, or other recycling matter. Typically such binding agents form no more than 10% of the biofuel pellet's mass and/or weight. In certain embodiments, the decomposed material can be used as a filler because it is stable and homogenous. In addition, in some embodiments, the service provider can sell the decomposed material as a soil amendment (e.g., a humus-rich soil amendment, nutrient rich soil, top soil, fertilizer for gardening or commercial farming, or the like). The service provider can also further process the decomposed material (e.g., by adding other materials) to create the soil amendment. In addition, because the decomposed material generally has a high caloric content, in some embodiments the decomposed material can be used as an animal feed.

In certain embodiments, the process 100 provides many advantages. For example, the process 100 can provide reduction of waste in terms of volume and/or weight at a customer's site. The reduced volume and weight can reduce hauling costs and carbon emission, which can enable receipt of carbon credit(s). Additionally, because the size of the waste can be smaller, pick up can occur less frequently. Transportation cost savings and carbon emission savings from fewer pick-ups can be retained by the service provider and/or passed on to the customer. Less pollution and carbon emission can also result from fewer hauling trips. Moreover, equipment for onsite reduction, recycling, and/or reuse can make the customer eligible for an investment tax credit and/or carbon credit The appreciation from the cost of the machine (and associated tax credit) can also provide a financial benefit to the customer.

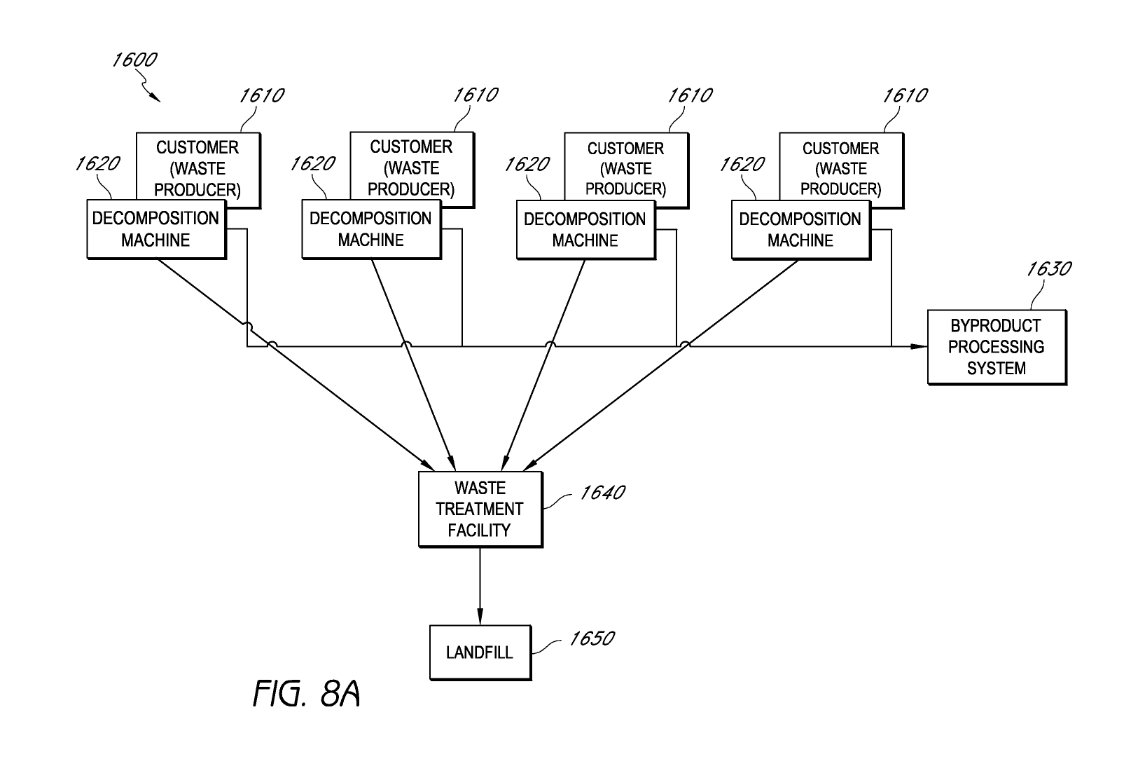

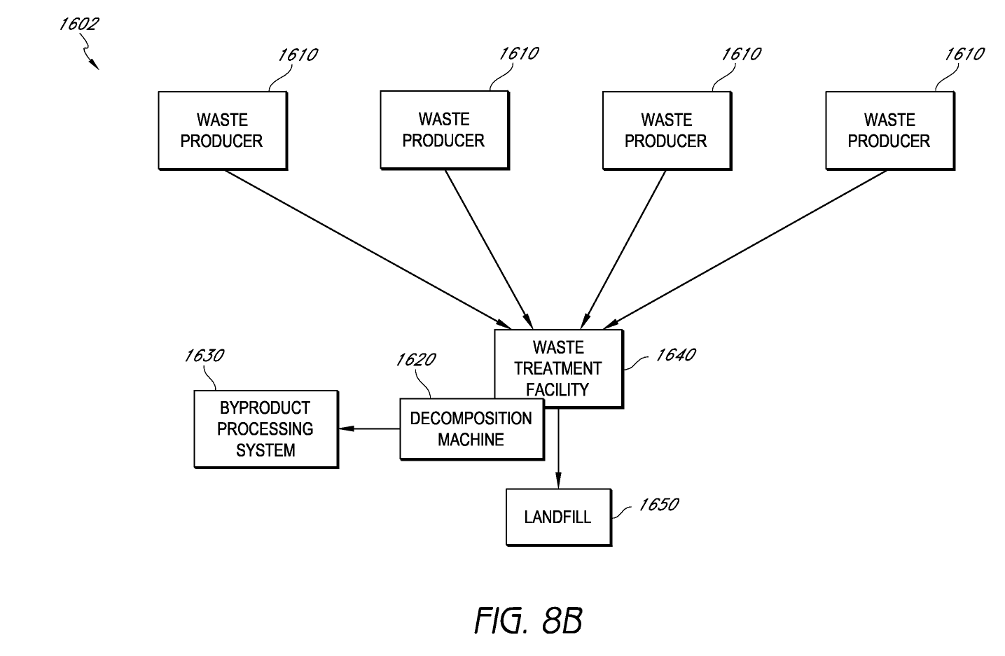

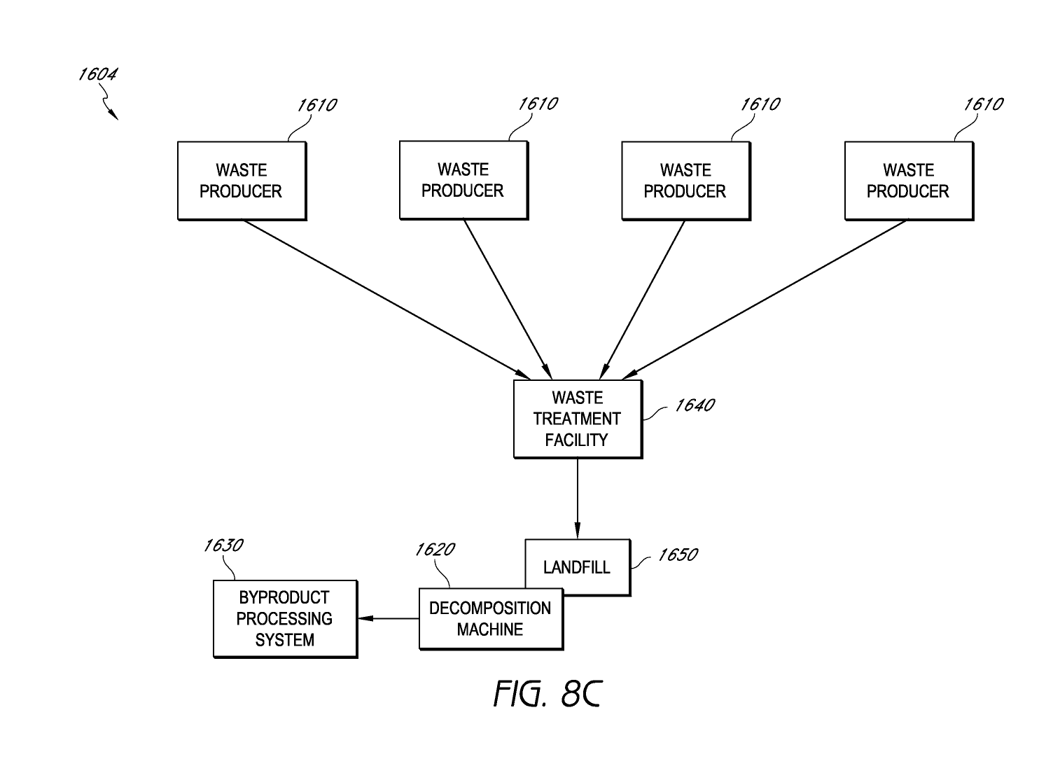

Further, carbon credits can be provided by a government agency or emissions management organization as part of an emissions trading system (e.g., cap-and-trade). One or more carbon credits can be provided, for example, for purchase or leasing of a decomposition machine, use of a decomposition machine, use of a waste management facility or landfill that employs a decomposition machine (see FIG. 8B et seq.), transport of waste to or from a facility that uses a decomposition machine, any combination of the same or the like. Carbon credits for the machine or any of these uses can be pre-certified by the government agency or emissions management organization. More generally, credits can be issued for any type of pollutant in place of the carbon or carbon dioxide pollutants described herein.

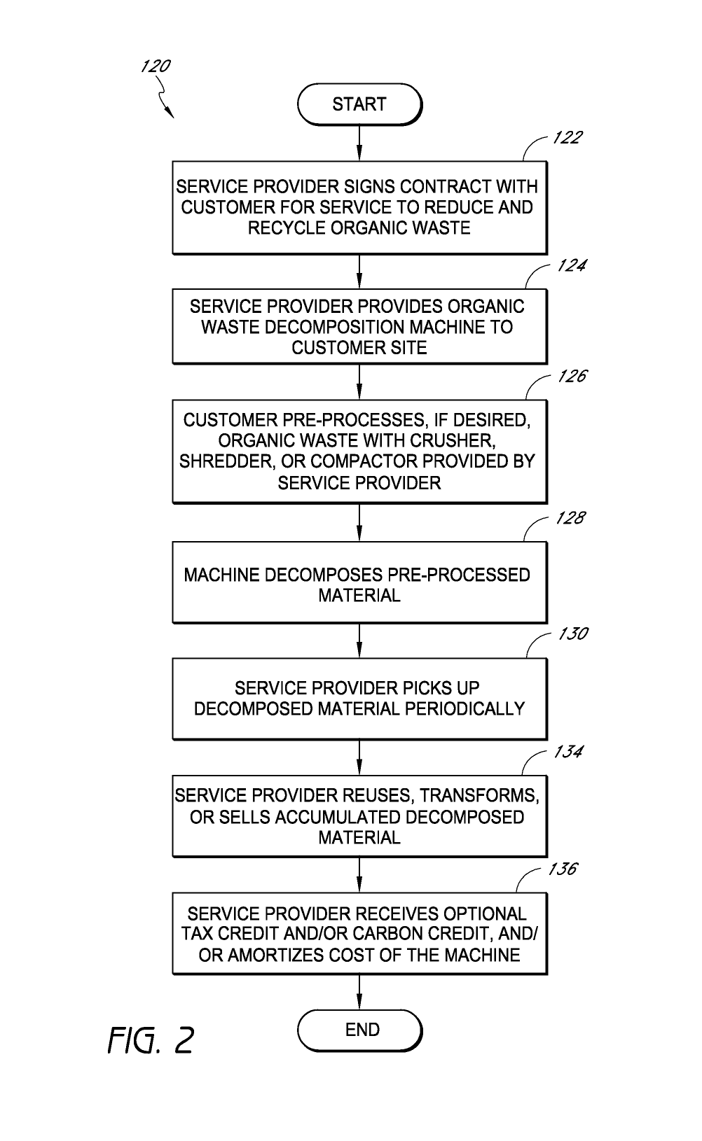

FIG. 2 illustrates another embodiment of a waste removal process 120. Some or all of the features of the waste removal process 120 can be used in conjunction with the features of the process 100 and vice versa. Advantageously, in certain embodiments, the waste removal process 120 provides a waste-producing customer with the benefits of an organic waste decomposition machine in exchange for providing the output of the machine to a provider of the machine.

At block 122, a service provider signs a contract or other agreement with the customer for a service to reduce and recycle organic waste. The service provider can charge a periodic (e.g., monthly) fee for this service. The fee can be negotiated based on the monthly waste hauling expense of the customer.

At block 124, the service provider provides an organic waste decomposition machine to the customer site, according to the contract. In one embodiment, the service provider provides the machine to the customer site. In another embodiment, the service provider provides the machine to another site designated by the customer (e.g., to the site that generates organic waste). Advantageously, the machine can reduce the volume and weight of the organic waste and transform the organic waste into clean water and high nutrient particles. Moreover, the machine can produce these outputs without producing environmentally negative byproducts, such as total suspended solids (TSS) or biochemical oxygen demand (BOD). Further, in certain embodiments, the machine can use electricity (e.g., from alternative energy sources such as solar-power or wind power) without using extra fresh water or additives, such as enzymes.

Continuing at block 126, the customer can pre-process the organic waste, if desired, by using a crusher, shredder, compactor or the like provided by the service provider. This pre-processing step can reduce the volume, processing time and weight of the organic waste processed by the machine. In one embodiment, the crusher and/or shredder (or other similar device) is integral with the machine or can be attached to the machine. The crusher, shredder, compactor or like device need not be provided by the service provider but can be provided by a third party vendor.

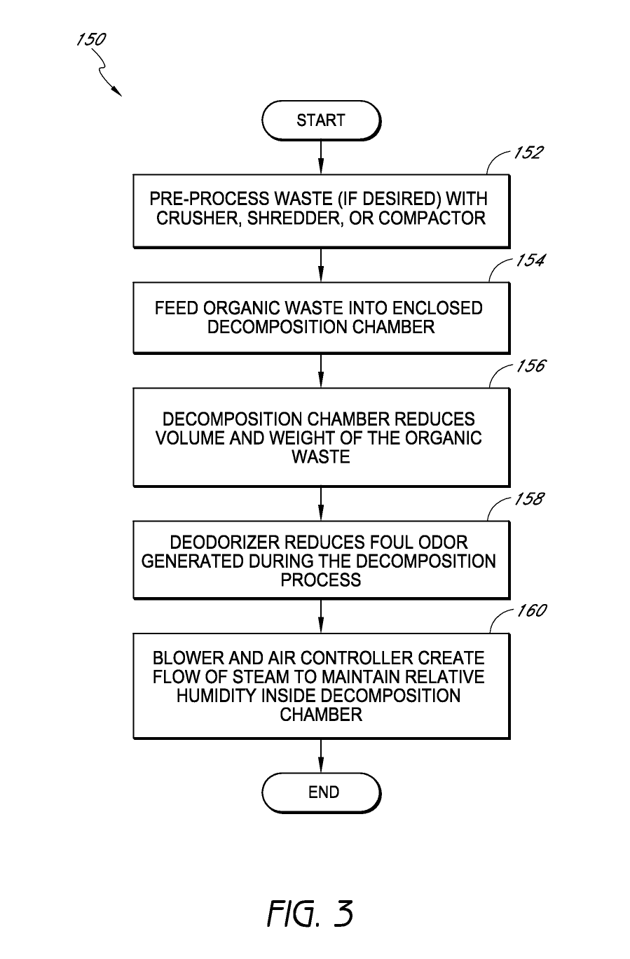

The machine can then decompose the pre-processed organic material at block 128. In one embodiment, the decomposition is performed according to the process described below with respect to FIG. 3. The customer can store the decomposed material into a waste bin that is separate from normal trash or organic disposal bins. The amount of byproducts can be recorded as a credit to the customer and can advantageously be used as reward points for the customer. Such points may be redeemed for valuable items, for example, to offset a rental fee, or as a credit for future goods or services. In addition, the customer can be provided with a profit sharing arrangement, where profits from the sale of the decomposed materials are shared in part with the customer.

The service provider, at block 130, picks up the decomposed material periodically. Instead of picking up the decomposed material every day, the service provider can pick up the material at longer time intervals to reduce carbon footprints caused by service vehicles. The frequency of the pickup in certain embodiments is based on, among other things, the quantity of the product material produced to advantageously reduce pickup, transfer, and landfill costs.

At block 134 of the process 120, the service provider reuses, transforms, or directly sells the accumulated decomposed material, as described above. At block 136, the service provider can advantageously receive a tax credit and/or carbon credit. In addition, the service provider can amortize the cost of the machine.

Thus, the benefits to the service provider of the processes 100 and 120 of FIGS. 1 and 2 can include 1) receiving compensation for the machine, 2) receiving compensation for pick-up fees, 3) receiving the decomposed material, 4) selling the decomposed material, 5) selling a transformed version of the decomposed material, 6) receiving tax or carbon credits, and 7) amortizing the cost of the machine, among other potential benefits. Some or all of these benefits may be found in certain embodiments; not all are may be present in any one embodiment.

### Example Organic Waste Decomposition Process

FIG. 3 illustrates an example waste decomposed process 150. The process 150 can advantageously be implemented by an organic waste decomposition machine that can be located at the site of waste generation, such as is described above. For example, an organic waste decomposition machine may be provided directly to an location near or at a restaurant, food court, mall, market, grocery store, farm, waste transfer station, landfills, etc. The process 150 can receive organic material as an input to the machine and can quickly and efficiently produce decomposed material as an output.

In addition, the process 150 can significantly reduce the weight and volume of waste organic material in an environmentally friendly manner. For example, in many embodiments, an organic waste decomposition machine such as those described herein, reduce the weight and/or volume of organic waste by about 80-93%, often at least 90%. Furthermore, the process 150 can convert organic waste into only highly concentrated biomass energy-rich granules and clean water.

Organic waste, such as food waste, is typically very difficult to recycle. For example, such waste is typically generates a foul odor, attracts rats, roaches, and other vermin, and/or can serve as a medium upon which dangerous bacteria (such as e. coli and salmonella) can grow. Furthermore, such waste must typically be transported to a landfill for composting or an incineration or biogas plant. Such typical processes waste large areas of land for composting, and/or generate a large carbon footprint resulting from transporting the bulky, heavy waste, and from generating CO₂ as result of incineration.

In contrast, the present methods avoid all of these drawbacks by providing clean, sanitary, on-site conversion of organic waste into a useful, commercially valuable decomposed material (sometimes referred to as a “byproduct”). The methods' resultant material is clean, and free of bacteria and other disease-transmitting agents. Furthermore, water generated from the waste is also clean, and may be used for irrigation, etc.

At block 152, organic waste is pre-processed by a customer (if desired) with a crusher, shredder, compactor, or the like, such as is described above. At block 154, the organic waste is fed into an enclosed decomposition chamber at block 154 of the organic waste decomposition machine. In one embodiment, the crusher, shredder, or the like can be located inside or outside of the decomposition chamber.

The decomposition chamber can include a heating oil chamber that is heated by a heating element. The heating oil can heat the organic waste and generate steam (or moisture) from the organic waste at a controlled temperature. For example, the temperature can be controlled at about 78 to about 85 degrees Celsius. This particular temperature range advantageously can avoid burning the waste through combustion. Other temperature ranges can also be used, such as 150 degrees Celsius for a faster conversion and dehydration process when the organic waste is pre-treated to handle larger volumes of organic waste. The controlled temperature may differ in various embodiments based at least in part on the pressure of the decomposition chamber. In addition, the temperature of other chambers may be different. For example, in one embodiment, the deodorizer operates at a temperature in the 250-300 degree Celsius range. Furthermore, the pressure can be adjusted, for example, based upon the desired temperature. In one embodiment, temperature, pressure, moisture and airflow sensors are used to monitor the status of the decomposition machine and to control the respective temperature, pressure, and airflow settings in order to advantageously achieve quick waste decomposition. For example, the water byproduct of the decomposition process may be converted to steam by controlling temperature, and by applying steam under pressure to waste, decomposition can be advantageously facilitate.

The decomposition chamber can reduce the volume and weight of the organic waste through a series of processes. The decomposition chamber can effectively divide the organic waste into condensate (e.g., water) and organic particles using heat, steam/moisture, controlled air circulation inside the chamber, and the like. Advantageously, in certain embodiments, no additives, such as enzymes or fresh water, are added in the process. In one embodiment, the decomposition chamber breaks the waste down into pieces or a porridge kind of waste. The waste can continue to dry as the decomposition chamber applies heat, producing small particles of decomposed material.

The decomposed material can be homogenous but need not be. In one embodiment, the decomposed material is generally dehydrated and/or a high carbon product (e.g., because the organic waste is not burned). C (carbon) O (oxygen) H (hydrogen) molecules in the organic waste can become C (carbon) molecules when the H₂O molecules are separated as water or hydrogen during decomposition. The decomposed material can also include other nutrients and/or minerals, including, but not limited to nitrogen and potassium. The composition of the decomposed material will depend upon the waste material initially provided to the decomposition machine.

Other devices besides the decomposition chamber that can be involved with the waste processing can include a heater, a filter or filters, an impeller and attached paddle arms (e.g., inside the decomposition chamber), a condenser, a water circuit, a blower, fans, a deodorizer, airflow/vapor circuits, temperature and/or humidity sensors, comparison units, and controllers, among others. (At least some of these devices are described in more detail below with respect to FIGS. 4 through 7.)

For example, at block 158, a deodorizer can reduce foul odor generated during the decomposition process (including for particularly foul odors generated from fat). In one embodiment, the deodorizer can use a metal catalyst to heat the vapor passing through the deodorizer to a temperature ranging from, for example, about 200 to about 500 degrees C. Other temperature ranges can be employed. The heat energy generated by the deodorizer can be re-used in the decomposition chamber.

As another example, at block 160, a blower and air can create an air flow of steam to maintain the relative humidity inside the decomposition chamber. In one embodiment, these devices add ambient air to the decomposition chamber to maintain the relative humidity inside the decomposition chamber at about 90%. Other humidity levels may also be used.

### Example Organic Waste Decomposition System

In certain embodiments, one or more of the processes described above with respect to FIGS. 1 through 3 can be implemented by an organic waste decomposition system described below. In some embodiments, the system can decompose organic waste in a decomposition chamber without use of enzymes, additives, or microorganisms and produce by-products have potential use as bio-mass and/or bio-fuel. In some embodiments, the system can be configured to decompose organic waste within 4 to 24 hours and deodorizes odor of the decomposing organic waste during decomposition process. The system can provide sufficient heat and operating conditions to evaporate moisture from the organic waste without burning the organic waste. The system can reuse or recycle water and heat used in the system for different processes in the system.

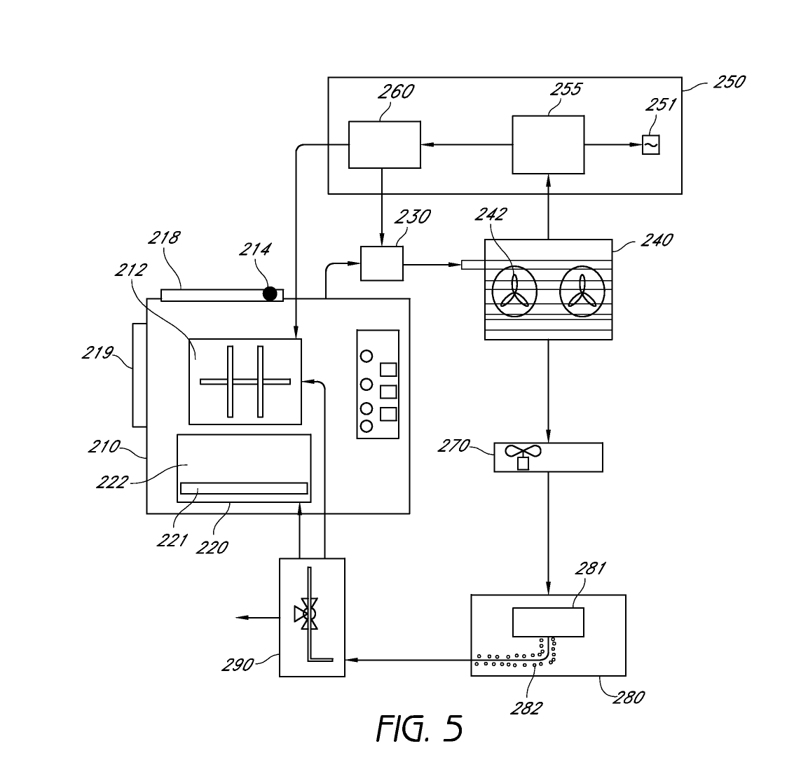

Referring to an illustrated embodiment as shown in FIGS. 4 and 5, the organic waste decomposition system (OWDS) includes a decomposition chamber 210, a heater 220, a filter 230, a condenser 240, a blower 270, a water circuit 250, a deodorizer 280, and a vapor circuit 290.

### Decomposition Chamber

The decomposition chamber 210 is where organic waste is decomposed. In one embodiment, the decomposition chamber 210 has an input door 218 for inputting or loading organic waste into the decomposition chamber 210. In one embodiment, an emergency stop switch 214 is provided such that the input door 218 can press the emergency stop switch 214 when the input door 218 is closed. However, when the input door 218 is open and the emergency stop switch 214 is unpressed, the operation of the OWDS is stopped. The decomposition chamber 210 further includes an output door 219 for outputting byproducts of the decomposition process. The capacity of the reaction chamber 210 can be determined by the amount of organic waste a user wants to decompose in a given time period. In some embodiments, the capacity or mass of the organic waste that the decomposition chamber 210 can be from about 10 kg to about 5000 kg, such as from about 30 kg to about twenty (20) tons or more. In embodiments, the decomposition chamber 210 can be substantially sealed when the input door 218 and the output door 219 are closed, except for tubing connected with other components of the OWDS which will be further described below.

In embodiments, the OWDS operates the organic waste decomposition process without burning or carbonization of the organic waste. To avoid burning or carbonization, the speed of dehydration from the decomposition chamber 210 has to be regulated. In embodiments, while the moisture content inside the decomposition chamber 210 constantly decreases during the operation, the OWDS maintains the inside of the decomposition chamber 210 humid until the organic waste is substantially decomposed and the volume has been substantially decreased.

For example, at least for several hours (about 3, about 4, about 5, about 6, about 7, about 8, about 9, about 10, about 11, about 12, about 13, about 14, about 15 hours) of operation, the relative humidity inside the decomposition chamber 210 stays above about 75%, about 76%, about 77%, about 78%, about 79%, about 80%, about 81%, about 81%, about 82%, about 83%, about 84%, about 85%, about 86%, about 87%, about 88%, about 89%, and about 90%, about 91%, about 92%, about 93%, about 94%, about 95%, about 96%, about 97%, about 98%, about 99%, and about 100%. Also, for example, at least for several hours (about 3, about 4, about 5, about 6, about 7, about 8, about 9, about 10, about 11, about 12, about 13, about 14, about 15 hours), the humidity inside the decomposition chamber 210 stays above about 75%, about 76%, about 77%, about 78%, about 79%, about 80%, about 81%, about 81%, about 82%, about 83%, about 84%, about 85%, about 86%, about 87%, about 88%, about 89%, and about 90%, about 91%, about 92%, about 93%, about 94%, about 95%, about 96%, about 97%, about 98%, about 99%, and about 100% of the highest humidity of the operation within the decomposition chamber 210.

### Crusher

When organic waste includes large pieces or chunks, making them smaller in size can help the decomposition process of the OWDS. In some embodiments, the OWDS can include a crusher or a dicer that can crush or dice the organic waste into smaller parts before getting decomposed. The crusher can be located inside or outside the decomposition chamber 210.

### Impeller

In embodiments, the OWDS includes an impeller 212 rotatable within the decomposition chamber 210 for mixing organic waste being processed in the decomposition chamber 210. Rotation of the impeller 212 can be controlled or regulated to distribute the organic waste substantially evenly within the decomposition chamber 210. The organic waste on the bottom is driven by the impeller paddles towards the top of the chamber 210 and dropped down due to gravity. In one embodiment, the impeller 212 can include a rotation bar with one or more arms or paddles extended from the rotation bar. The one or more arms are configured to mix the organic waste. In some embodiments, the one or more arms can be perpendicular to the rotation bar or attached at an angle to the rotation bar. The impeller 212 can be configured and/or controlled to rotate in one direction during decomposing process to help distribute the organic waste and rotate in the other direction to push the decomposed waste out after the decomposing process.

### Heater

In the illustrated embodiment as shown in FIGS. 4 and 5, the heater 220 can provide heat to the decomposition chamber 210. The heater 220 can include a heating member 221 and a liquid medium 222 to indirectly heat the decomposition chamber 210. The liquid medium 222 can include oil, water, etc. The liquid medium 222 generally has a high heat retention property to retain heat therein. In one embodiment, at least some portion of the heater 220 contacts the decomposition chamber 210 to heat the decomposition chamber 210. In another embodiment, the heating member 221 can heat the decomposition chamber 210 directly.

In one embodiment, the heating member 221 can heat the liquid medium 222 to a temperature from about 110° C. to about 150° C., such as about 120° C. to about 140° C. The heater 220 is controlled to heat the decomposition chamber 210 such that the temperature inside the decomposition chamber 210 can be at about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, about 100, about 101, about 102, about 103, about 104, or about 105° C. The temperature inside the decomposition chamber 210 is maintained within a range formed by two of the numbers listed in the immediately previous sentence.

The foregoing temperature ranges within the decomposition chamber 210 can decompose the organic waste without burning them when sufficient moisture is provided within the decomposition chamber 210. As the heater 220 heats the decomposition chamber 210 over time, moisture within organic waste in the decomposition chamber 210 starts to evaporate and released into the decomposition chamber 210. In some embodiments, heating of the heater 220 can be controlled by a controller of the OWDS throughout the process. The heater 220 can controllably heat the decomposition chamber 210 in order to desiccate the organic waste without burning them. In one embodiment, the heater 220 can be turned off and on in order to maintain a certain temperature range within the decomposition chamber 210. Although not limited, the heater 220 uses electricity for generating heat.

### Filter

In the illustrated embodiment as shown in FIGS. 4 and 5, the filter 230 is disposed near or at a steam outlet of the decomposition chamber 210, where steam is discharged from the decomposition chamber 210. In embodiments, the steam through the filter 230 is directed to the condenser 240 through at least one conduit or pipe. The filter 230 screens debris or dirt that is mixed within moisture coming from the decomposition chamber 210. If the debris from organic waste is not filtered by the filter 230, they can cause clogging in the conduit or pipe, and also they can reach the condenser 240 and/or a water tank of the water circuit 250 and cause clogs therein. In one embodiment, the filter 230 can include at least one porous screen.

In some embodiments, the filter 230 can include more than one screen with varying sizes of pores. Size of the pores of the filter screens can vary from a few millimeters to a few microns. In one embodiment, the filter 230 can be flushed with water to wash away debris trapped on the screen(s) of the filter 230. The water to flush the filter 230 can be provided from an external source or recycled from the water tank of the water circuit 250. In one embodiment, the filter 230 can be replaced periodically to remove used clogged filter 230.

### Condenser

In the illustrated embodiment as shown in FIGS. 4 and 5, the condenser 240 is in fluid communication with the decomposition chamber 210 and configured to receive the steam from the decomposition chamber 210. The condenser 240 is to precipitate or condense at least some of the steam coming from the decomposition chamber 210 into water. The steam minus the condensed water (or vapor) through the condenser 240 can be provided to the deodorizer 280 via blowing of the blower 270. In some embodiments, the condenser 240 condenses moisture contained in the steam at a condensation rate of about 50%, about 52%, about 54%, about 56%, about 58%, about 60%, about 62%, about 64%, about 66%, about 68%, about 70%, about 72%, about 74%, about 76%, about 78%, about 80%, about 82%, about 84%, about 86%, about 88%, or about 90%. In embodiments, at least one of temperature at the condenser 240 and flowing speed of the steam through the condenser 240 is set or controlled to achieve a range of condensation rate defined by any two numbers listed in the immediately previous sentence.

In one embodiment, the condenser 240 can include at least one pipe 41 for allowing flow of steam therethrough. In some embodiments, the at least one pipe 41 can have fins running spirally, straight, or across on an exterior of the at least one pipe for better heat conduction with the cooler external environment. The condenser 240 can further include one or more cooling fans 42 for blowing air to cool the at least one pipe 41 of the condenser 240. The condensed water from the condenser 240 can be sent to a water reservoir or a water tank of the water circuit 250.

### Water Circuit

In the illustrated embodiment as shown in FIGS. 4 and 5, the water circuit 250 can collect condensed moisture (water) from the condenser 240 and distribute the water to various components. The water circuit 250 can include a water tank 255 and a water pump 260. The water tank 255 is to at least temporarily store water condensed from the condenser 240. The water pump 260 is to pump or flow precipitated water from the water tank 255 towards various components of the OWDS.

In one embodiment, the water circuit 250 is in fluid communication with the condenser 240 and the decomposition chamber 210. The water circuit 250 supplies precipitated water from the condenser 240 to the decomposition chamber 210 when extra moisture is needed within the decomposition chamber 210 for the organic waste to decompose without burning. The water pump 260 is to pump the water to the decomposition chamber 210. This process can be controlled by a controller of the OWDS. In another embodiment, the water circuit 250 is in further connection with the filter 230 and supplies the water the filter 230 for flushing the filter screen(s). The water in the water tank 255 can be pumped by the water pump 260. Again, flushing can be controlled by a controller of the OWDS.

In one embodiment, at least some of the water stored in water tank 255 can be discarded to outside of the OWDS. The water discarded to outside is pre-processed through a water filter 51 to minimize pollution. The water filter 51 can include activated carbon filters. Although not illustrated, water from an external source can be supplied to the OWDS for flushing the filter 230 and/or for supplementing moisture to the decomposition chamber 210 when needed. The water from the external source can be pumped into the OWDS by the water pump 260.

### Blower

In the illustrated embodiment as shown in FIGS. 4 and 5, the blower 270 can control flow of air or steam through pipes and components of the OWDS. In the illustrated embodiment, the blower 270 is generally in fluid communication with the decomposition chamber 210, the condenser 240, and the deodorizer 280, and drives the flow of the steam and vapor from the decomposition chamber 210 to the condenser 240 to the deodorizer 280. In one embodiment, the blower 270 can flow at least some of the vapor to discharge to outside of the OWDS.

In one embodiment, the blower 270 is set or controlled to flow the steam from the decomposition chamber 210 at a flow rate that can maintain certain desired level of humidity inside the chamber 210 through the decomposition process. In one embodiment, the flow rate is controlled or set such that the relative humidity within the decomposition chamber 210 is maintained with less than about 20% variation, such as about 19, about 18, about 17, about 16, about 15, about 14, about 13, about 12, about 11, about 10, about 9, about 8, about 7, about 6, and about 5% variation, for at least several hours, for example, at least about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27 hours. In one embodiment, the blower 270 is controlled to substantially continuously flow the steam out of the decomposition chamber 210. In one embodiment, the flow rate is set at a constant rate for at least several hours.

In some embodiments, flow rate of air or steam controlled by the blower 270 can be related to a size or capacity of the decomposition chamber 210. In one embodiment, the flow rate of air controlled by the blower 270 can be generally proportional to the size of the reaction chamber 210. The blower 270 can be set to create the flow rate, which is, for example, from about 2 to about 4 times the interior volume of the decomposition chamber 210 for 1 minute. In one embodiment, the flow rate of air controlled or set by the blower 270 at about 800 liter/min, about 2800 liter/min, about 4000 liter/min, about 8000 liter/min, and about 12000 liter/min for decomposition chamber capacities of about 220 L, about 850 L, about 1250 L, about 2500 L, and about 3900 L, respectively.

### Deodorizer

In the illustrated embodiment as shown in FIGS. 4 and 5, the deodorizer 280 is in fluid communication with the condenser 240 and the blower 270 to receive vapor (some steam that has passed the condenser 240). The deodorizer 280 processes vapor to remove odor before discharging to outside the system. In embodiments, the deodorizer 280 includes a catalyst 82 that is effective in removing odor from the vapor. For example, the catalyst 82 includes Pt, Ni, Ru, Rh, Pd, Ag, Fe, Co, and Ir. In one embodiment, the deodorizer 280 further includes a deodorizer heater 281 to heat the vapor to a temperature at which the catalyst 82 is active or activated. For example, the deodorizer heater 281 can heat the vapor to a temperature from about 200° C. to about 500° C.

### Vapor Circuit

In the illustrated embodiment as shown in FIGS. 4 and 5, the vapor circuit 290 is in fluid communication between the deodorizer 280 and the heater 220. The connection from the deodorizer 280 to the vapor circuit 290 can be insulated so as to substantially minimize loss of heat of the vapor. In one embodiment, the conduit from the deodorizer 280 to the vapor circuit 290 can include a ceramic carrier 283.

The vapor circuit 290 recycles the heat produced in the deodorizer 280 by returning heated vapor from the deodorizer chamber 210 or by using the heated vapor to heat the liquid medium 222. In one embodiment, the vapor circuit 290 includes a heat insulated conduit to flow therethrough the vapor that has been heated through the deodorizer 280. The vapor circuit 290 can further include an air flow controller or valve 91 that regulates receiving of ambient air and/or release vapor. In one embodiment, the combination of the vapor and the ambient air can be provided to the decomposition chamber 210. In one embodiment, the vapor circuit 290 can send at least part of vapor that has passed the deodorizer 280 to the liquid medium of the heater 220.

### Optional Pretreatment System

Although not shown, the systems illustrated in FIGS. 4 and 5 can include a pretreatment system for treating biodegradable municipal waste (BMW). The pre-treatment system may include: a sorter that can sort waste such that inorganic waste and difficult-to-process organic waste is separated out from treatable organic waste; a shredder that can shred the sorted organic waste into smaller pieces; a compactor or squeezer that can remove water from—and reduce the volume of—the shredded organic waste; a conduit fluidly connecting the compactor to the water circuit of the system that can supply reclaimed water to the water circuit of the system; and input and output doors and/or chutes to input BMW into the BMW pre-treatment system and output pre-treated organic waste.

The sorter of the foregoing system may include: an input door or chute that can introduce BMW into the sorter; a conveyor belt that can spread out and move BMW through the sorter; a perforated rotating cylindrical screen that can remove waste particles smaller than the diameter of the perforations; a hydraulic sedimentation tank that can separate out inorganic waste, such as PET bottles, according to density; an electromagnetic separator that can separate out metal waste via an electric current; sensors on and around the conveyor belt that can detect metals and other non-usable materials such that magnets, blasts of air, and the like may be used to separate out the non-usable waste materials; and an output door or chute for outputting the sorted waste to the shredder. The conveyor belt itself can also sort waste by being positioned at an incline or decline such that waste with different densities may fall towards one end of the belt as it is being moved.

The shredder of the foregoing system may include: an input door or chute that can introduce the sorted waste into the shredder; shredding media (e.g., metal blades, tumblers, mills, etc) that can contact the sorted waste and break it up into smaller pieces for further processing; a surface or surfaces upon which the sorted organic waste can rest while the shredding media contact with, and break up, the waste; and an output door or chute for outputting the shredded organic waste to the compactor.

The compactor of the foregoing system may include: an input door or chute that can introduce the shredded waste into the compactor; a matrix with apertures providing outlets for water squeezed from the shredded waste; compacting media (e.g., a piston, a large screw, etc) that can push the shredded waste towards the matrix; a conduit in fluid communication with the water circuit of the system that can provide reclaimed water to the water circuit; and an output feeding mechanism for providing the compacted, de-watered waste to the carbon recovery system.

### Control System

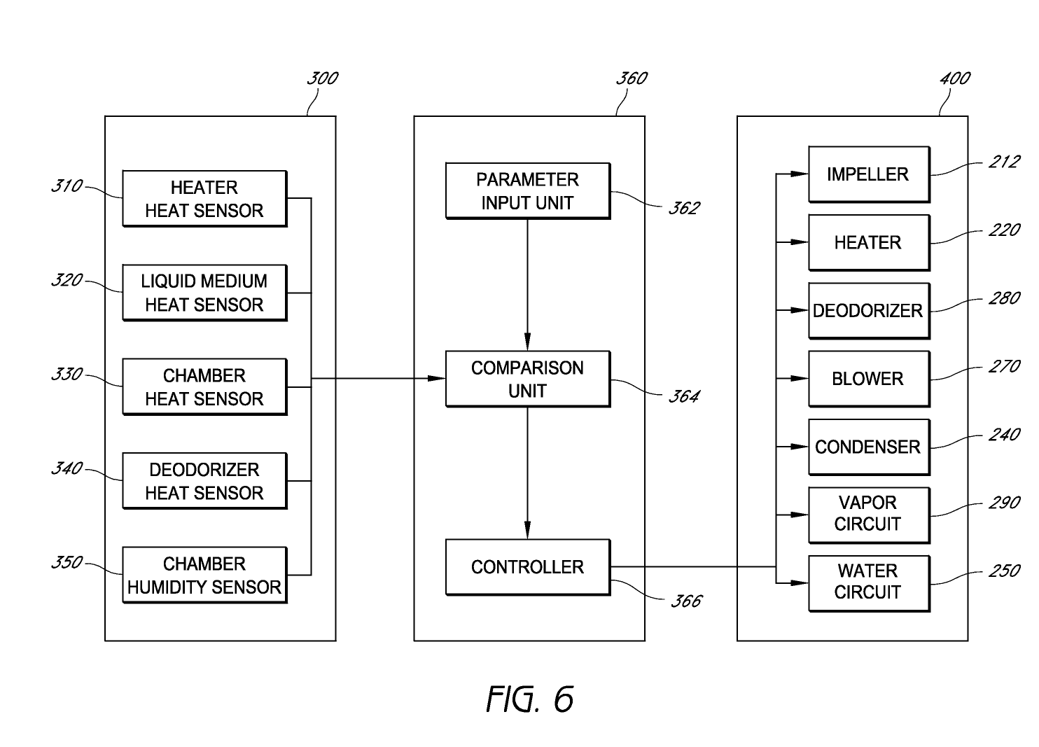

Referring to a block diagram as shown in FIG. 6, the organic waste decomposition system (OWDS) includes a control unit 360, a control input 300, and system components 400. The control input 300 can send information relating to operating conditions of the OWDS to the control unit 360. The control unit 360 can analyze the information and send signals to control the system components 400 of the OWDS to operate under desired conditions.

In the illustrated embodiment, the control input 300 includes a plurality of sensors 310, 320, 330, 340, and 350 that monitor the process of the OWDS and send signals to the control unit 360. The control unit 360 can analyze the signals from the control input 300 and control the operation of the OWDS by controlling at least some of the components of the system components 400. Although not shown, the control input 300 can include other sensors, such as a moisture sensor.

In the illustrated embodiment, the control unit 360 includes a parameters input unit 362, a comparison unit 364, a controller 366, and a timer 240. In one embodiment, the parameter input unit 362 includes a control panel or an interface in which a user of the OWDS inputs data or various parameters or reference values for operating for the OWDS, such as desired temperature in the decomposition chamber 210, desired humidity in the decomposition chamber 210, desired flow rate of the blower 270, etc. The parameter input unit 362 can also set the time for decomposing the organic waste within the OWDS, such as from about 18 hours to about 24 hours. The information from the parameter input unit 362 is provided to the comparison unit 364. The parameter input unit 362 can include a computer, a solid state relay circuit, etc.

The comparison unit 364 receives input values from the parameter input unit 362 and compares them to the signals from the control input 300. The signals from the control input 300 can contain data relating to operating conditions or status of the OWDS during processing. The comparison unit 364 can analyze the signals from the control input 300 with the reference values from the parameter input unit 362 to determine if the signals from the control input 300 are within range of the reference values of the parameter input unit 362. If the signals are not within the pre-determined range, the comparison unit 364 sends control commands or signals to the controller 366 to control at least some of the system components 400 of the OWDS to meet the desired operating conditions. In turn, the controller 366 send control signals to appropriate system component 400 to adjust operating condition accordingly.

In one embodiment, the control input 300 includes a heater heat sensor 310, a liquid medium heat sensor 320, a decomposition chamber heat sensor 330, a deodorizer heat sensor 340, and a decomposition chamber humidity sensor 350. The heater heat sensor 310 can monitor the temperature of the heating member 221 of the heater 220 (of FIG. 4.) The liquid medium heat sensor 320 can monitor the temperature of the liquid medium 222 of the heater 220. The decomposition chamber heat sensor 330 can monitor temperature inside the decomposition chamber 210. The deodorizer heat sensor 340 can monitor temperature inside the deodorizer 280. The decomposition chamber humidity sensor 350 can monitor the relative humidity inside the decomposition chamber 210. The control input 300 is electronically connected to the comparison unit 364 and provides the sensed information as signals to the comparison unit 364.

In one embodiment, the system components 400 include the impeller 212 within the decomposition chamber, the heater 220, the deodorizer 280, the blower 270, the condenser 240, the vapor circuit 290, and the water circuit 250. The system components 400 are electronically connected to the controller 366 to be controlled by the controller 366. The impeller 212 can be controlled to determine the speed and/or direction of the rotation of the impeller 212 of the decomposition chamber 210. The heater 220 can be controlled to determine the amount of heat generated by the heater 220 and, consequently, transferred to the decomposition chamber 210. The deodorizer 280 can be controlled to determine proper temperature inside the deodorizer 280 to active the catalysts 82 in order to remove odor or smell that can be given off by the decomposing organic waste. The blower 270 can be controlled to determine the flow rate of the steam, and/or vapor from the decomposition chamber 210 through the condenser 240. The condenser 240 can be controlled to determine how much the cooling fans 42 of the condenser 240 can blow external air to the cooling pipes of the condenser 240 in order to precipitate water from the steam flowing therethrough. The vapor circuit 290 can be controlled to determine how much external air along with the vapor from the deodorizer 280 can be provided to the decomposition chamber 210 and/or the liquid medium 222. The water circuit 250 can be controlled to determine how much water from the water tank 255 and/or external water source can be provided back to the decomposition chamber 210, to the filter 230, or discarded out.

### Flow of Water and Air

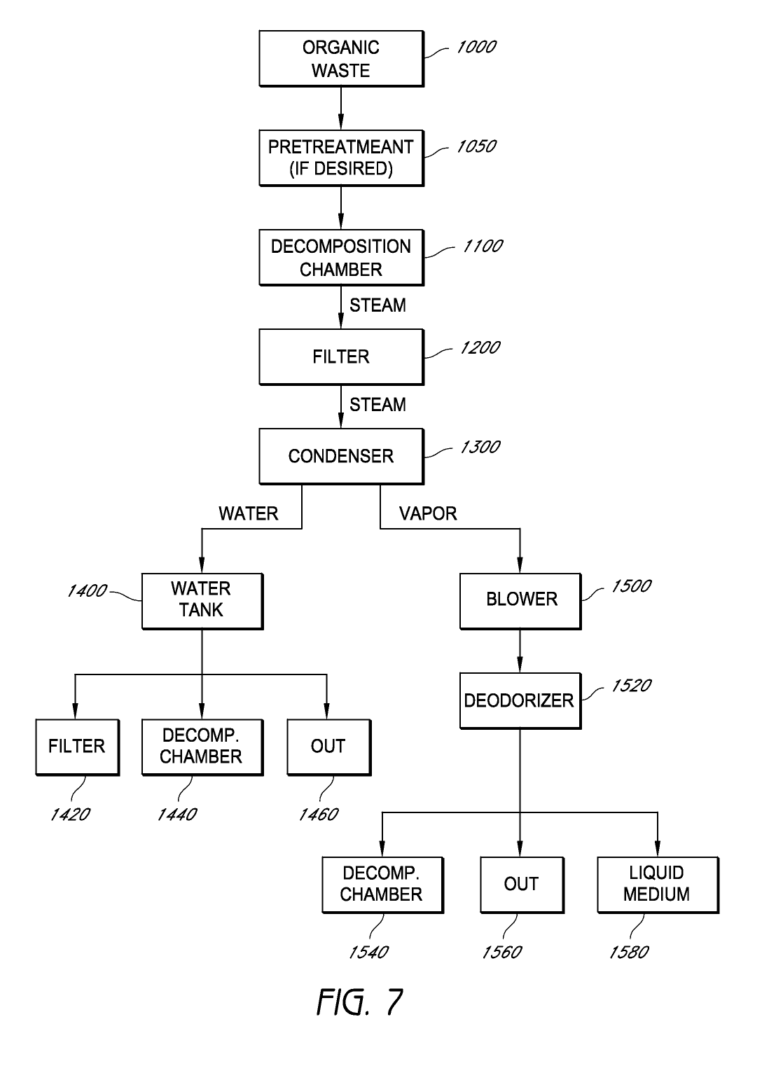

FIG. 7 illustrates flow of water and air during an organic waste decomposing process by the OWDS. In the illustrated embodiment, each block represents a stage during flow of water (moisture) and air in different components of the OWDS. Initially in block 1000, moisture is kept in organic waste before the process. As the process begins the moisture comes out of the organic waste into the decomposition chamber 210. The moisture and steam in the decomposition chamber 210 then is flown through filter 230, to condenser 240 where at least some of it precipitates into water. The water from the condenser 240 moves to water tank 255. Then the water in the water tank 255 can be separated to the filter 230 to flush the filter 230, the decomposition chamber 210, and discarded outside. Some vapor passes from the condenser 240 to the blower 270, move to the deodorizer 280, and separate and move to decomposition chamber 210 and discarded outside.

In one embodiment, block 1000 represents initial moisture content of the organic waste loaded into the decomposition chamber 210 (of FIG. 4.) In one embodiment, the decomposition chamber 210 uses heat and moisture released from the organic waste itself to decompose the organic waste. The decomposition chamber 210 can decompose organic waste therein by heating the organic waste to release moisture and continue heating the organic waste to remove moisture and decompose without burning the organic waste. The heat needed to heat the organic waste can be provided from the heater 220 that can be at least partially surrounding the decomposition chamber 210. As the temperature inside the reaction chamber 210 (of FIG. 4) rises, the moisture within the organic waste starts to evaporate. The evaporated moisture or steam starts to build inside the reaction chamber 210.

Pretreatment can be performed at block 1050 using, for example, the pretreatment components described above with respect to FIGS. 4 and 5. In one embodiment, pretreatment can be selectively performed based on a user input and may therefore be optional. Block 1100 represents the steam in the reaction chamber 210. The OWDS maintains the air within the decomposition chamber 210 humid with the steam for at least part of the process of decomposing organic waste. The steam in the decomposition chamber 210 can be blown through the filter 230 (of FIG. 4) by the blower 270 (of FIG. 4). Block 1200 represents the steam passing through the filter 230. The steam can be blown towards the condenser 240 (of FIG. 4) by the blower 270. At least some of the debris in the steam can be filtered by the filter 230. Block 130 represents the steam in the condenser 240. In the condenser 240, at least part of the steam can be separated into water and air. The water from the steam can be collected in the water tank 250 (of FIG. 4) and the less humid air after the condenser 240 can be blown through the blower 270.

Block 1400 represents the water in the water tank 255. In some embodiments, at least some of the water in the water tank 255 can be pumped by the water pump 260 (of FIG. 4) to reuse or recycle the water within different units of the OWDS. In some embodiments, water can be used to flush the filter 230 and wash off at least some of the debris on the screen of the filter 230. Water flushed through the filter 230 can be represented by block 1420. In some embodiments, some of the water in the water tank 255 can be returned to the organic waste in the reaction chamber 210 in order to provide enough moisture in the organic waste to prevent them from burning. The water pumped back to the reaction chamber 210 can be represented by block 1440. In some embodiments, some water in the water tank 255 can be discarded from the OWDS. Block 1460 represents the water drawn outside of the OWDS.

Block 1500 represents the vapor blown through the blower 270 from the condenser 240. The vapor through the blower 270 can be provided to the deodorizer 280 (of FIG. 4). Block 1520 represents the vapor from the blower 270 through the deodorizer 280. In one embodiment, the flow of the vapor can be controlled by the vapor circuit 290 (of FIG. 4). Block 1540 represents that at least some of the vapor from the deodorizer 280 can be blown back to the decomposition chamber 210 to recycle the heat retained within the air fro the deodorizer 280. Block 1560 represents some of the air from the deodorizer 280 can be blown outside the OWDS. Block 1580 represents some of the air is returned to heat the liquid medium 222.

### Decomposition Business Models

FIGS. 8A through 8C illustrate example decomposition business models 1600, 1602, and 1604, respectively. The different decomposition business models shown illustrate that the decomposition machine described herein can be used at any point in a waste treatment chain, including at a customer location, waste treatment facility, or landfill.

For example, referring specifically to FIG. 8A, decomposition machines 1620 are depicted as being used at customer (or waste producer) sites 1610. Byproducts from the decomposition machines 1620 can be collected and sent to a byproduct processing system 1630. The byproduct processing system 1630 can use the byproducts to produce fertilizer, syngas, other biofuels, or the like as described above. In addition, the byproduct processing system 1630 can transform the decomposed material using a thermochemical conversion process, such as hydrogastification, to produce biofuels. This process can be performed instead at the customer sites 1610 in one embodiment. Performing this process at the customer sites 1610 may be effective if the amount of decomposed material is substantially large.

Inorganic or other waste can be collected and sent to a waste treatment facility 1640, which further processes the waste and sends the waste to a landfill 1650, incinerator, or the like. The decomposition business model 1600 shown therefore enables decomposition at the waste producer sites 1610, thereby reducing transportation costs and/or carbon emissions associated with hauling waste from the waste producer sites 1610.

Some waste producers may prefer not to purchase or lease a decomposition machine 1620. Instead, the decomposition machine 1620 can be provided directly to the waste treatment facility 1640 or to the landfill 1650. FIG. 8B illustrates a decomposition business model 1602 where a decomposition machine (or machines) 1620 is used at the waste treatment facility 1640. FIG. 8C illustrates a decomposition business model 1602 where a decomposition machine (or machines) 1620 is used at the landfill 1650. Using a decomposition machine 1620 at the waste treatment facility 1640 or landfill 1650 can provide the benefit of waste recycling even when waste producers prefer not to purchase or lease a machine.

The byproduct processing system 1630 shown in FIGS. 8B and 8C can be located at a separate facility from the water treatment facility. Alternatively, the byproduct processing system 1630 can be installed and operated at the waste treatment facility 1640 or landfill 1650. Installing the byproduct processing system 1630 can allow byproducts such as syngas (synthetic gas) or other synthetic biofuels to be produced at the waste treatment facility 1640 or landfill 1650. With the decomposition machine 1620 and byproduct processing system 1630, the facility 1640 or landfill 1650 can convert biosolids into highly concentrated biomass feedstock and process this feedstock with a hydrogasification process to produce syngas or substitute natural gas (e.g., carbon monoxide, methane, or the like). The combination of the decomposition machine 1620 and/or byproduct processing system 1630 can help waste management facilities 1640 and/or landfills 1650 handle the hundreds of tons of waste that they process on any given day.

Any combination of the business models 1600, 1602, and 1604 may be used in some embodiments. For example, a decomposition machine 1620 may be used by some of the waste producers 1610 but not others. The waste treatment facility 1640 or landfill 1650 could use a decomposition machine 1620 for the waste producers 1610 who do not have a decomposition machine 1620. Similarly, the landfill 1650 may include a decomposition machine 1620 and can receive waste from multiple waste treatment facilities 1640, some of which may have a machine 1620 and others of which may not.

In another embodiment, the waste producers 1610 can use a pretreatment machine that includes the pretreatment functionality described above. The pretreatment machine can produce pretreated waste that can be collected and transported to the waste treatment facility 1640. The waste treatment facility 1640 and/or landfill 1650 can include a decomposition machine 1620 that further processes the pretreated waste. Similarly, the waste treatment facility 1640 can use a pretreatment machine, which can produce pretreated waste that can be collected and transported to the landfill 1650.

Moreover, the waste producer 1610, waste treatment facility 1640, and/or landfill 1650 can include any subcomponents of the decomposition machine 1620 to effectively subdivide the decomposition process among the waste producer 1610, waste treatment facility 1640, and/or landfill 1650. Alternatively, the waste producer 1610, waste treatment facility 1640, and/or landfill 1650 can each have a fully functional decomposition machine. Many other configurations are also possible.

### Terminology

Depending on the embodiment, certain acts, events, or functions of any of the processes or algorithms described herein can be performed in a different sequence, can be added, merged, or left out all together. Thus, in certain embodiments, not all described acts or events are necessary for the practice of the processes.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A method of managing organic waste decomposition, the method comprising:
providing an organic waste decomposition machine adapted to transform organic waste into decomposed material at a first site, the organic waste decomposition machine configured to decompose the organic waste by at least heating the organic waste to produce decomposed material;
collecting the decomposed material output by the organic waste decomposition machine; and
transporting the decomposed material to a second site;
wherein said collecting and transporting the decomposed material are performed in exchange for one or more of the following: said providing the organic waste decomposition machine, a service fee, and carbon credit.

2. The method of claim 1, further comprising transforming the decomposed material into one or more of the following: an organic filler for acrylonitrile butadiene styrene (ABS) resin, animal feedstock, a soil amendment, and biomass feedstock for biomass fuel.

3. The method of claim 1, wherein the decomposition machine is further configured to pretreat the organic waste prior to decomposing the organic waste.

4. A method of managing organic waste decomposition, the method comprising:
providing an organic waste decomposition machine adapted to transform organic waste into decomposed material at a first site, the organic waste decomposition machine configured to apply heat to the organic waste in a decomposition chamber to produce decomposed material;
collecting the decomposed material output by the organic waste decomposition machine; and
transporting the decomposed material to a second site.

5. The method of claim 4, wherein said collecting and transporting the decomposed material are performed in exchange for said providing the organic waste decomposition machine.

6. The method of claim 4, wherein said collecting and transporting the decomposed material are performed in exchange for a service fee.

7. The method of claim 4, wherein said collecting and transporting the decomposed material are performed in exchange for a carbon credit.

8. The method of claim 4, wherein the organic waste decomposition machine is further configured to at least partially recycle water generated from the organic waste.

9. The method of claim 8, wherein the organic waste decomposition machine is further configured to apply the recycled water to the organic waste to avoid burning the organic waste.

10. The method of claim 4, further comprising transforming the decomposed material into one or more of the following: a filler for acrylonitrile butadiene styrene (ABS) resin, a soil amendment, and a biomass fuel.

11. The method of claim 4, wherein the organic waste decomposition machine is configured to transform the organic waste into the decomposed material.

12. The method of claim 4, further comprising providing a credit to an operator of the first site, an amount of the credit depending at least partly on an amount of the decomposed material collected.

13. The method of claim 4, wherein said collecting the decomposed material is performed according to an arrangement between an operator of the first site and a provider of the organic waste decomposition machine.

14. A method of managing organic waste decomposition, the method comprising:
providing an organic waste decomposition machine to a facility, the organic waste decomposition machine adapted to decompose organic waste at the facility, the decomposition machine configured to transform decomposed organic waste into a byproduct;
arranging to receive the byproduct output by the organic waste decomposition machine for transportation to a second facility;
wherein said arranging to receive the decomposed material output by the organic waste decomposition machine is performed in exchange for one or more of the following: said providing the organic waste decomposition machine, a service fee, and carbon credit.

15. The method of claim 14, wherein the byproduct comprises one or more of the following: a filler for acrylonitrile butadiene styrene (ABS) resin, animal feed, a soil amendment, and biomass feedstock for biofuel.

16. The method of claim 14, further comprising certifying the carbon credit, a value of the carbon credit depending at least partly on an amount of the decomposed organic waste produced.

17. The method of claim 14, further comprising certifying the carbon credit, a value of the carbon credit depending at least partly on an amount of the decomposed organic waste transported.

18. The method of claim 14, further comprising certifying the carbon credit, a value of the carbon credit depending at least partly on an amount of the decomposed byproduct produced.

19. The method of claim 14, further comprising certifying the carbon credit, a value of the carbon credit depending on usage of the organic waste decomposition machine at the facility.

20. The method of claim 14, wherein said collecting the byproduct is performed according to an arrangement between an operator of the facility and a provider of the organic waste decomposition machine.

21. The method of claim 14, wherein the facility is a waste treatment facility.

22. The method of claim 14, wherein the facility is a landfill.
